(19) United States
(12) Patent Application Publication
(10) Pub. No.: US 2015/0172347 A1
(43) Pub. Date: Jun. 18, 2015

(54) PRESENTATION OF CONTENT BASED ON PLAYLISTS

(71) Applicants: Johannes P. Schmidt, Los Altos Hills, CA (US); Mark T. Edson, Lake Stevens, WA (US)

(72) Inventors: Johannes P. Schmidt, Los Altos Hills, CA (US); Mark T. Edson, Lake Stevens, WA (US)

(21) Appl. No.: 14/133,440

(22) Filed: Dec. 18, 2013

(51) Int. Cl. H04L 29/06

(52) U.S. Cl. CPC H04L 65/602

(57) ABSTRACT

In embodiments, apparatuses, methods and storage media are described that are associated with presentation of content using playlists. In various embodiments, a presentation engine (“PE”) may consult a playlist associated with a content selection. The playlist may include playlist elements that are associated with time periods and may identify one or more pieces of content for presentation. The PE may facilitate retrieval and queuing of the pieces of content. In various embodiments, a hierarchical playlist may include one or more playlist elements at one or more hierarchical levels. In various embodiments, the PE may be configured to present content as directed by playlist elements at higher levels before consulting playlist elements at lower levels. For example, given a playlist that directs presentation of particular content, new content may be substituted through introduction of new higher-level playlist elements. Other embodiments may be described and claimed.

### TECHNICAL FIELD

The present disclosure relates to the field of data processing, in particular, to apparatuses, methods and systems associated with presentation of content.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Content, such as video and audio content, is increasingly frequently provided via streaming or download over wired or wireless networks. In many systems, multiple pieces of content may be provisioned for consumption by a user. These pieces of content may be downloaded and queued for presentation by a content consumption device. However, in various scenarios, presentation of content may present challenges. Additionally, the content consumption device may need to switch between one or more pieces of content, such as when displaying advertising interstitially between portions of a larger piece of content. However, each piece of content may require time to retrieve and present to a viewer, lessening the viewing experience. In another example, pre-recorded content may include older content that is less desirable to show at later times, such as outdated news or advertising. In other embodiments, content may associated with restrictions which may affect how the content may be presented to a viewer.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for content distribution and consumption, in accordance with various embodiments.

FIGS. 2a and 2b illustrates an example playlist as well as examples of queuing of content for presentation according to the example playlist, in accordance with various embodiments.

FIG. 3 illustrates an example arrangement of various entities associated with the use of playlists for presentation of content, in accordance with various embodiments.

FIG. 4 illustrates an example process for presentation of content as facilitated by playlists, in accordance with various embodiments.

FIG. 5 illustrates an example process for facilitating presentation of content for a time period as directed by a playlist, in accordance with various embodiments.

FIG. 6 illustrates an example computing environment suitable for practicing various aspects of the present disclosure, in accordance with various embodiments.

FIG. 7 illustrates an example storage medium with instructions configured to enable an apparatus to practice various aspects of the present disclosure, in accordance with various embodiments.

### DETAILED DESCRIPTION

Embodiments described herein are directed to, for example, methods, computer-readable media, and apparatuses associated with presentation of content using playlists. In various embodiments, a presentation engine (“PE”) of a content consumption device may consult a playlist associated with a content selection. The playlist may include playlist elements that are associated with time periods (such as, for example time periods relative to a start of presentation of content, and/or absolute time periods) and may identify one or more pieces of content for presentation during the time periods. The PE may facilitate retrieval and queuing of the pieces of content for playback. In various embodiments, by facilitating downloading and queuing of multiple pieces of content as directed by the playlist, the PE may present a more seamless experience to a user.

In various embodiments, the playlist may include a hierarchical playlist, which may include one or more playlist elements at one or more hierarchical levels. In various embodiments, the PE may be configured to present content as directed by playlist elements at higher levels before consulting playlist elements at lower levels. In various embodiments, the use of multiple hierarchical levels may facilitate various presentation features. For example, given a playlist that directs presentation of particular content, new content may be substituted through introduction of new higher-level playlist elements. This substitution may be utilized, for example, on content that includes older advertisements to introduce newer, more contemporary advertisements. In other embodiments, the playlist elements may include one or more restrictions on presentation of content. For example, a playlist element may include a restriction on fast-forwarding or other navigation that is permitted during the playlist element's associated time period. In some embodiments, playlists may be modified to include playlist elements at higher levels to introduce such presentation restrictions without requiring modification of content itself, such as to enforce blackout restrictions. Other embodiments and additional implementation examples are described below.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

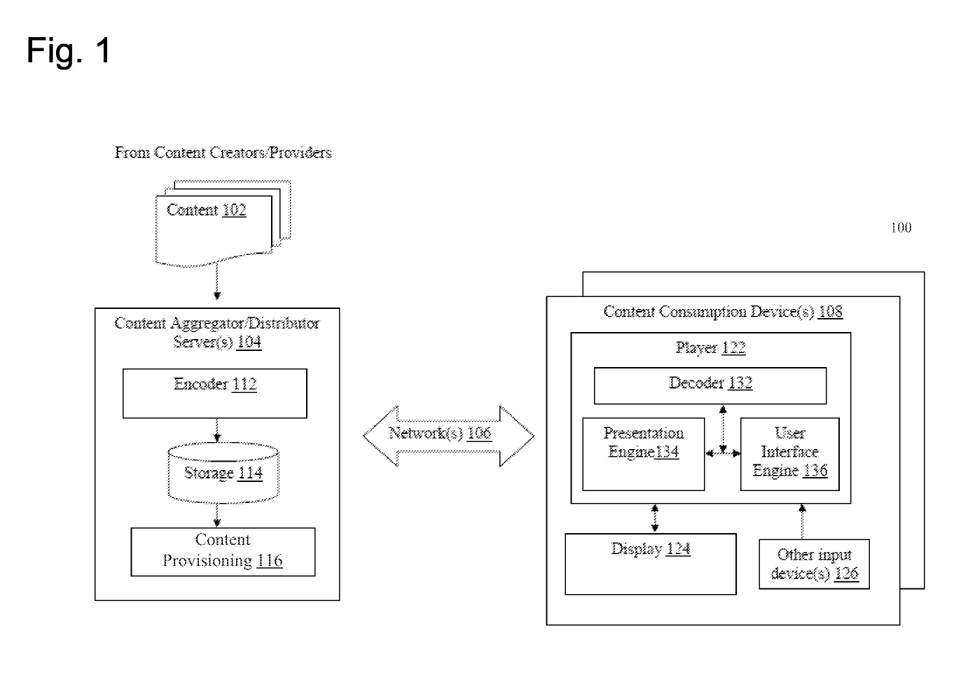

Referring now to FIG. 1, an arrangement 100 for content distribution and consumption, in accordance with various embodiments, is illustrated. As shown, in embodiments, arrangement 100 for distribution and consumption of content may include a number of content consumption devices 108 coupled with one or more content aggregator/distributor servers 104 via one or more networks 106. Content aggregator/distributor servers 104 may be configured to aggregate and distribute content to content consumption devices 108 for consumption, e.g., via one or more networks 106. In various embodiments, content presentation techniques described herein may be implemented in association with arrangement 100. In other embodiments, different arrangements, devices, and/or systems maybe used.

In embodiments, as shown, content aggregator/distributor servers 104 may include encoder 112, storage 114 and content provisioning 116, which may be coupled to each other as shown. Encoder 112 may be configured to encode content 102 from various content creators and/or providers 101, and storage 114 may be configured to store encoded content. Content provisioning 116 may be configured to selectively retrieve and provide encoded content to the various content consumption devices 108 in response to requests from the various content consumption devices 108. Content 102 may be media content of various types, having video, audio, and/or closed captions, from a variety of content creators and/or providers. Examples of content may include, but are not limited to, movies, TV programming, user created content (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In various embodiments, for efficiency of operation, encoder 112 may be configured to encode the various content 102, typically in different encoding formats, into a subset of one or more common encoding formats. However, encoder 112 may be configured to nonetheless maintain indices or cross-references to the corresponding content in their original encoding formats. Similarly, for flexibility of operation, encoder 112 may encode or otherwise process each or selected ones of content 102 into multiple versions of different quality levels. The different versions may provide different resolutions, different bitrates, and/or different frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

In various embodiments, content provisioning 116 may be configured to provide encoded content as discrete files, portions of files, and/or as continuous streams of encoded content. Content provisioning 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth. In various embodiments, content provisioning 116 may be configured to provide media files that are packaged according to one or more output packaging formats.

In various embodiments, content aggregator/distributor servers 104 may not include the encoder 112 but may still include the storage 114 and/or the content provisioning 116. In various embodiments, the content aggregator/distributor servers 104 may include one more servers which may be separately addressable and/or may be configured to separately provide encoded content.

Networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which content aggregator/distributor server 104 communicate with content consumption devices 108. Similarly, at the content consumption end, networks 106 may include base stations and/or access points, through which consumption devices 108 communicate with content aggregator/distributor server 104. In between the two ends may be any number of network routers, switches and other networking equipment of the like. However, for ease of understanding, these gateways, firewalls, routers, switches, base stations, access points and the like are not shown.

In various embodiments, as shown, a content consumption device 108 may include player 122, display 124 and user input device(s) 126. Player 122 may be configured to receive streamed content, decode and recover the content from the content stream, and present the recovered content on display 124, in response to user selections/inputs from user input device(s) 126.

In various embodiments, player 122 may include decoder 132, presentation engine 134 (“PE 134”) and user interface engine 136. Decoder 132 may be configured to receive streamed content, decode and recover the content from the content stream. PE 134 may be configured to present the recovered content on display 124, in response to user selections/inputs. In various embodiments, decoder 132 and/or PE 134 may be configured to present audio and/or video content to a user that has been encoded using varying encoding control variable settings in a substantially seamless manner. Thus, in various embodiments, the decoder 132 and/or PE 134 may be configured to present two portions of content that vary in resolution, frame rate, and/or compression settings without interrupting presentation of the content. User interface engine 136 may be configured to receive signals from user input device 126 that are indicative of the user selections/inputs from a user, and to selectively render a contextual information interface as described herein.

While shown as part of a content consumption device 108, display 124 and/or user input device(s) 126 may be stand-alone devices or integrated, for different embodiments of content consumption devices 108. For example, for a television arrangement, display 124 may be a stand alone television set, Liquid Crystal Display (LCD), Plasma and the like, while player 122 may be part of a separate set-top set, and user input device 126 may be a separate remote control (such as described below), gaming controller, keyboard, or another similar device. Similarly, for a desktop computer arrangement, player 122, display 124 and user input device(s) 126 may all be separate stand alone units. On the other hand, for a tablet arrangement, display 124 may be a touch sensitive display screen that includes user input device(s) 126, and player 122 may be a computing platform with a soft keyboard that also includes one of the user input device(s) 126. Further, display 124 and player 122 may be integrated within a single form factor. Similarly, for a smartphone arrangement, player 122, display 124 and user input device(s) 126 may be likewise integrated.

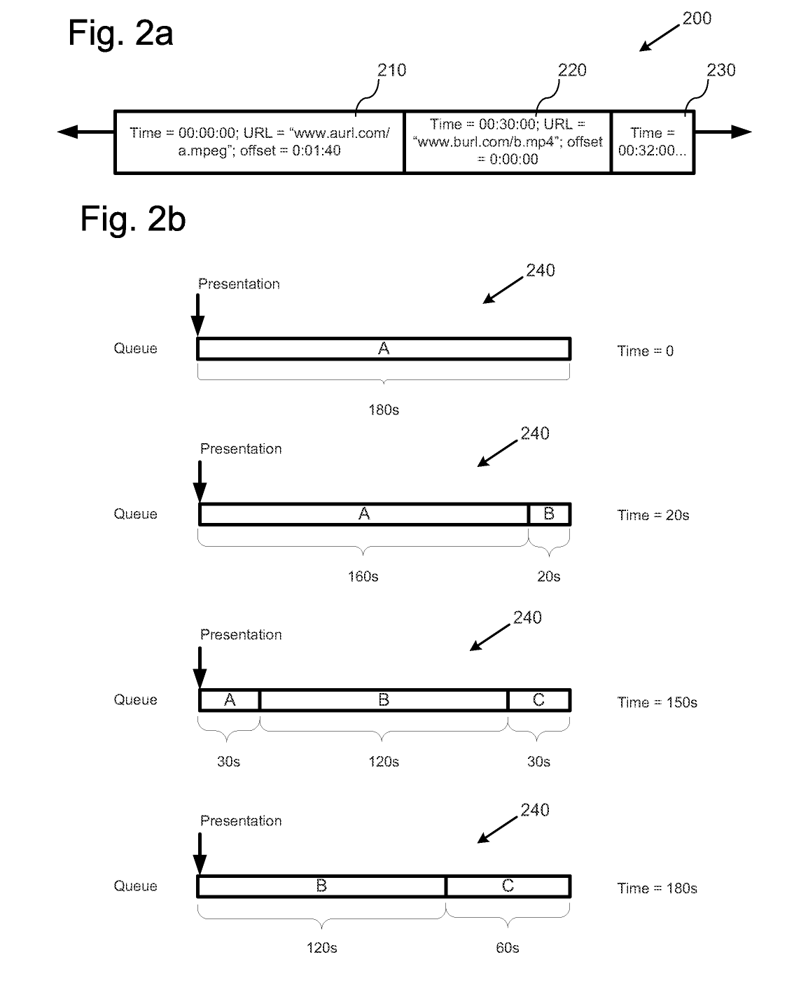

Referring now to FIG. 2a, an example playlist 200 is illustrated. In various embodiments the playlist may be associated with a content selection. For example, the playlist may be associated with a television channel, a television episode, movie, sporting event, other live event, song, piece of online video, etc. In various embodiments, the playlist may direct presentation of one or more pieces of content associated with a content selection. For example, a playlist associated with a television episode may include content for the television episode itself, along with content for advertisements, promotions for other content, etc.

In various embodiments, the playlist may include one or more playlist elements that may be configured to direct presentation of one or more pieces of content associated with the content selection. For example, playlist 200 may include a playlist for a television channel featuring a piece of episodic content identified by playlist element 210, an advertisement identified by playlist element 220, and another piece of episodic content identified by playlist element 230. In various embodiments, the playlist elements may include an indication of a time at which presentation of content should be directed by the playlist element. For example, playlist element 210 indicates that its associated piece of content should begin at time 00:00:00, playlist element 220 indicates that its associated piece of content should begin 30 minutes later at time 00:30:00, and playlist element 230 indicates that its associated piece of content should begin 2 minutes later at time 00:32:00. In various embodiments, the indication of the time may be absolute (for example 03:30:00) or relative (for example 30 minutes after presentation begins).

In various embodiments, a playlist element may include information to identify a piece of content and direct presentation of the content. In various embodiments, this information may include an identification of a location for a piece of content. For example, in playlist 200, playlist element 210 includes an indication that its associated piece of content may be retrieved from www.aurl.com/a.mpeg, and playlist element 220 includes an indication that its associated piece of content may be retrieved from www.burl.com/b.mp4. In various embodiments, locations indicated in playlist elements may point to various online and offline locations, such as content delivery networks, servers, or local storage. Additionally, in various embodiments, the pieces of content identified by the playlist elements may include pieces of content in different formats, as well as streaming content and/or content files that are downloadable as whole files.

In various embodiments, the playlist elements may also include an offset value indicating where in the piece of content to begin presentation. For example, the offset value of playlist element 210 indicates to begin presentation at 1 minute and 40 seconds into the piece of content, while the offset value of playlist element 220 indicates to begin presentation of its associated piece of content 0 minutes and 0 seconds—the beginning of the piece of content. As described below, in various embodiments, some playlist elements may not identify pieces of content, but may instead identify one or more restrictions on presentation of content (not illustrated in FIG. 2a).

In various embodiments, the PE 134 may be configured to facilitate presentation of the one or more pieces of content by queuing content for presentation, such as by a media player (implemented in hardware and/or software) and associated with the PE 134. In may be recognized that various methods of queuing content for presentation are known by those of ordinary skill. In various embodiments, the PE 134 may be configured to queue content successively according to playlist elements of a playlist, such that portions of multiple pieces of content may be queued during presentation.

For example, referring now to FIG. 2b, examples are shown of queuing of pieces of content for presentation according to the example playlist 200 of FIG. 2a in accordance with various embodiments. In the example of FIG. 2b, a queue 240 includes memory for 180 seconds of content. In the example, portions of the queue marked “A” refer to portions of the piece of content referred to by playlist element 210, referred to herein as “piece of content A”. Similarly, portions of the queue marked “B” refer to portions of the piece of content referred to by playlist element 220 (referred to herein as “piece of content B”), and portions of the queue marked “C” refer to portions of the piece of content referred to by playlist element 230 (referred to herein as “piece of content C”).

In the first example, at a time of 00:27:00, piece of content A is being presented, and the queue is entirely filled with portions of piece of content A, as there are 180 seconds left of piece of content A. However, 20 seconds later, at time 00:27:20, piece of content A has been completely queued. The PE 134 may therefore be configured to queue portions of piece of content B, here the first 20 seconds of piece of content B, so that the queue may continue to be filled as piece of content A is presented. Continuing to the third example, at time 00:29:30, only the last 30 seconds of piece of content A remain in the queue, while all 120 seconds of piece of content B have been queued, and the first 30 seconds of piece of content C are also queued. Finally, at time 00:30:00, all of piece of content A has been presented. However, because piece of content B was queued immediately following piece of content A, the PE 134 can immediately begin presentation of piece of content B following the end of piece of content A. Additionally, piece of content C finds its first 60 seconds queued to be presented after presentation of piece of content B.

As the example shows, in various embodiments, by queuing content as directed by the playlist elements of a playlist, the PE 134 may be able to better facilitate presentation of a content selection. In particular, as pieces of content are queued, one after the other, the PE may perform the presentation of content in a more seamless fashion than if retrieval and queuing of each individual piece of content were to be performed after the end of the piece of content that precedes it.

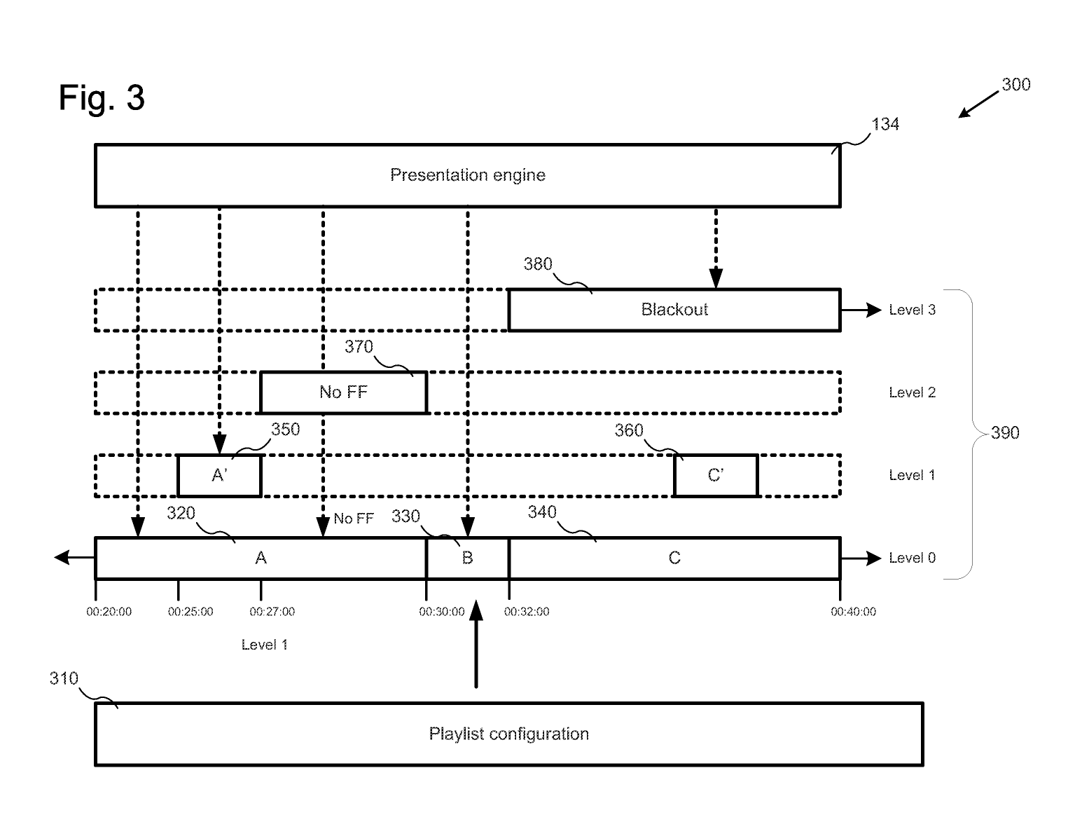

Referring now to FIG. 3, an example arrangement 300 of various entities associated with the use of playlists for presentation of content is illustrated in accordance with various embodiments. In various embodiments, a playlist configuration module 310 (“PC 310”) may be configured to obtain one or more playlists to direct presentation of content by the PE 134. In various embodiments, the PC 310 may be configured to retrieve playlists from an external entity, such as, for example, content aggregator/distributor server 104. In some embodiments, the PC 310 may be configured to obtain modifications to playlists from external entities as well. In another embodiments the PC 310 may be configured to generate playlists and/or modifications to playlists on its own. For example, the PC 310, which may be included in the content consumption device 108, may be configured to receive indications of pieces of content to associate with a content selection, and to generate a playlist from these received indications. In various embodiments, the PC 310 may also be configured to modify one or more playlists before or during presentation of content to a viewer.

In various embodiments, the PC 300 and PE 134 may be configured to interoperate with hierarchical playlists, such as playlist 390 of FIG. 3. In various embodiments, a hierarchical playlist may include playlist elements associated with multiple levels. For example, playlist 390 includes playlist elements associated with four different levels (levels 0-3). In various embodiments, the PE 134 may be configured to consult the hierarchical playlist by viewing, during a given time period, multiple playlist elements that are associated with that time period. For example, in various embodiments, the PE 134 may consult the hierarchical playlist at regular intervals, such as, for example, one second time periods, and determine if there are multiple playlist elements associated with the time period. In other embodiments, time periods may not be regular, and the PE 134 may consult a hierarchical playlist only for times where there are differences in the hierarchical playlist. For example, the PE 134 may consult the hierarchical playlist from a current time during which there is a current set of playlist elements associated with the time up until a later time at which the set of playlist elements associated with that time changes. As illustrated in the example of FIG. 3, examples of such time periods may be 00:20:00 to 00:25:00, 00:25:00 to 00:27:00, 00:27:00 to 00:30:00, and 00:30:00 to 00:32:00.

In various embodiments, the PE 134 may be configured to direct presentation of one or more pieces of content based on the levels of the playlist elements, such that a playlist element at a higher level in the hierarchical playlist may take priority over a lower-level playlist element. (Note: as used here, in the term priority may imply which playlist element is used in case of a conflict between elements, and does not necessarily mean any sort of time-based priority.)

In a example, during the time period from 00:20:00 to 00:25:00, the PE 134 may consult the playlist 390 and determine that there is only one playlist element (playlist element 320) associated with that time period. In some embodiments, the time period may be divided into multiple smaller time periods for purposes of consulting the playlist 390, though there may still be only one playlist element 320 associated with these time periods. In either event, during this time period, the presentation of content may be directed by the one playlist element 320 associated with the time period, and so the PE 134 may be equipped to queue portions of piece of content A for presentation during that time period. Similarly, only piece of content B may be queued for presentation during the time period 00:30:00 to 00:32:00, because there is only playlist element 330 associated with that time period.

As mentioned above, however, in some embodiments, the PC 310 may obtain a playlist with multiple elements (or modify a playlist to include multiple elements) in a given time period. For example, in FIG. 3, the PC 310 has modified the playlist to include a playlist element 350 at level 1 during the time period between 00:25:00 and 00:27:00. As there are two playlist elements 320 and 350 associated with this time period, the PE 134 may be configured to queue the piece of content (A′) associated with playlist element 350 for this time period rather than piece of content A, whose associated playlist element 320 is at level 0. In various embodiments, the PE 134 may be configured to resume queuing of piece of content A for time 00:30:00 after queuing of piece of content A′ is complete.

As such, the PC 310 may effectively substitute a new piece of content for a piece of content associated with a lower-level playlist element, and may be facilitated in doing so even when the two pieces of content are not of the same length. In various embodiments, the PC 310 may thus be configured to substitute new pieces of content in for portions of a piece of content rather than requiring that an entire piece of content be substituted. This may allow the PC 310 to perform more selective and efficient substitution of content than might otherwise be available. One example of such a selective substitution might be a substitution of advertising into a piece of content, such as to replace older advertising that may pre-exist as part of the piece of content. In various embodiments, new content may be substituted through the introduction of playlist elements at a higher level than those playlist elements for the content being replaced. In other embodiments, one or more playlist elements may be themselves substituted at the same level without introducing playlist elements at a higher level.

As mentioned above, some playlist elements may include restrictions on presentation of content rather than indications of content. In some embodiments, restrictions may include restrictions on navigation, speed of presentation, or other presentation options. For example, the example playlist 390 includes a playlist element 370 at level 2 that is not associated with any particular piece of content, but which directs that the PE 134 not allow fast-forwarding of content during its associated time period (e.g., 00:27:00 to 00:30:00). In various embodiments, the PE 134 may be configured to consult the playlist 390, see that there is a restriction directed by the playlist element 370 during that time period, and to present piece of content A as directed by that restriction during that time period. Thus, a viewer of the content selection associated with playlist 390 would not be able to fast-forward during the period 00:27:00 to 00:30:00. Similarly, if a viewer of the content selection associated with playlist 390 were fast-forwarding before 00:27:00, such as starting at 00:25:00, the PE 134 may require that fast-forwarding stop when the time reaches 00:27:00.

Similarly, playlist element 380 includes a blackout restriction during time period 00:32:00 to 00:40:00. Such a restriction may be issued to prevent viewing of content during certain times, by certain viewer, and/or in certain geographical areas. In various embodiments, the PC 310 may be configured to modify the playlist 390 to include playlist element 380 to effect such a blackout restriction. In such an embodiment, the PE 134 may ignore any lower-level associated content once consulting the playlist 390 and seeing the playlist element 380 with the blackout restriction. Thus, the PE 134 may not present either piece of content C or C′ (associated with playlist elements 340 and 360, respectively) during this time period.

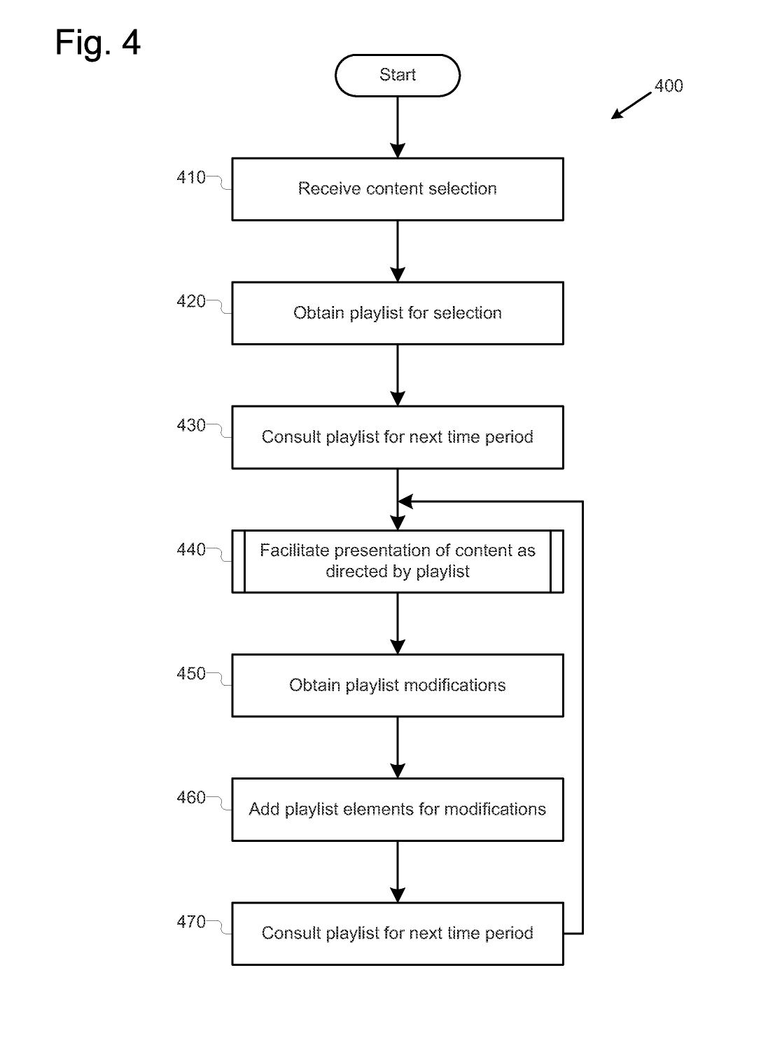

Referring now to FIG. 4, an example process 400 for presentation of content as facilitated by playlists is illustrated in accordance with various embodiments. While FIG. 4 illustrates particular example operations for process 400, in various embodiments, process 400 may include additional operations, omit illustrated operations, and/or combine illustrated operations. In various embodiments, operations of process 400 may be performed by the PC 310 and/or the PE 134.

The process may begin at operation 410, where the PE 134 may receive a content selection. In various embodiments, the PE 134 may receive a selection of a particular content title, such as a movie, television episode, and/or song. In other embodiments, the PE 134 may receive a selection of a content source, such as a television channel, online video source, branded video collection, etc. In other embodiments, at operation 410, the PE 134 may receive a selection of an event, such as a sporting event, an arts event, or other live events. In yet other embodiments, the PE 134 may receive a selection of a user-created content collection or playlist. Next, at operation 420, the PC 310 may obtain a playlist for the selection. In various embodiments, the PC 310 may retrieve a playlist from a remote location, such as from content aggregator/distributor server 104. In other embodiments, the PC 310 may generate a playlist locally and/or retrieve a locally-stored playlist.

Next, at operation 430, the PE 134 may consult the playlist for a next time period. In various embodiments, the time period may be a relative time period (e.g, 0 seconds from present, 30 seconds from present, etc.) or may be an absolute time period (e.g. 03:00:00.) In some embodiments, the time period may be a regular interval (such as 1 second) or may be a time period relating to one or more playlist elements.

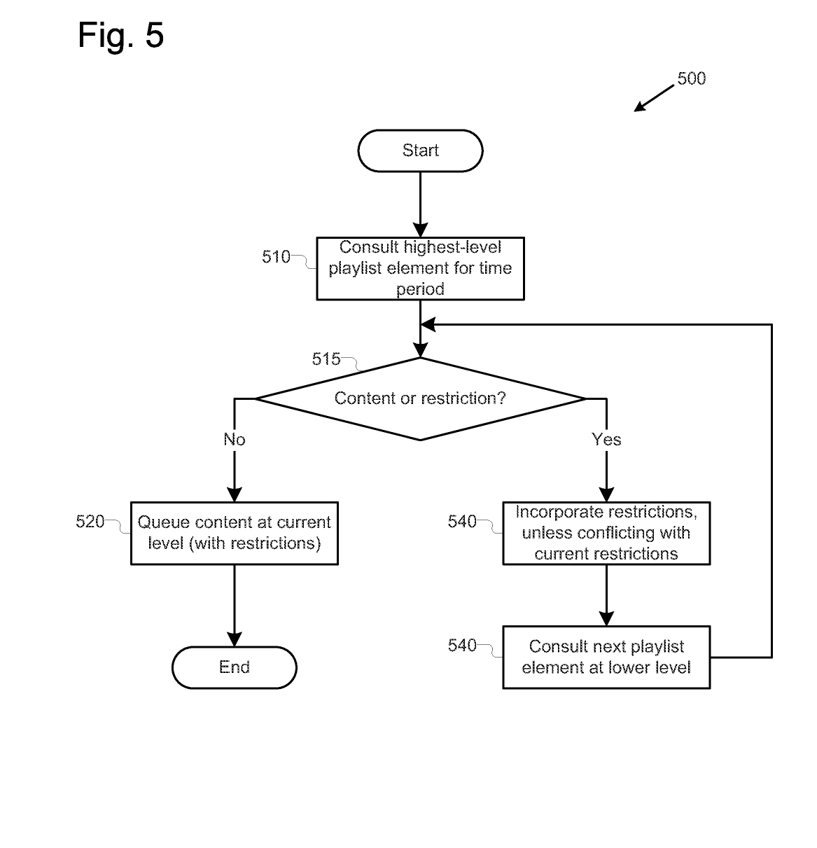

At operation 440, the PE 134 may facilitate presentation of one or more pieces of content as directed by the playlist. Various embodiments and implementation details of operation 440 may be described below with reference to process 500 of FIG. 5.

Next, at operation 450, the PC 310 may obtain modifications to the playlist. In various embodiments, the modifications may be received from a remote location, such as content aggregator/distributor server 104 (such as, for example, in a late-arriving blackout notification). In other embodiments, modifications to the playlist may be received from a user. For example, a viewer may select a different piece of content to be viewed “up next,” after a current piece of content is complete. This may result in a modification to the playlist to substitute content over a piece of content that is currently in the playlist. In some embodiments, no modifications may be obtained by the PC 310 at operation 450.

At operation 470, the PC 310 may add one or more playlist elements to the playlist to affect modifications received at operation 460 (if any were received). For example, if a first piece of content is to be substituted for second piece of content, then a higher-level playlist element associated with the second piece of content may be added for the same time period as the playlist element associated with the first piece of content. Next, at operation 460, the PE 134 may consult the (possibly modified) playlist for the next time period and may then return to operation 440 to facilitate presentation of the content as directed by the (possibly modified) playlist. If there is no next time period associated with the playlist, the process may end (not illustrated).

Referring now to FIG. 5, an example process 400 for facilitating presentation of content for a time period as directed by a playlist is illustrated in accordance with various embodiments. While FIG. 5 illustrates particular example operations for process 500, in various embodiments, process 500 may include additional operations, omit illustrated operations, and/or combine illustrated operations. In various embodiments, process 500 may be performed to implement operation 440 of process 400 of FIG. 4. In various embodiments, process 500 may be performed by the PE 134.

The process may begin at operation 510, where the PE 134 may consult the highest-level playlist element for the time period for which the PE is facilitating presentation. Next, at decision operation 515, the PE 134 may determine whether the playlist element identifies with piece of content or a restriction. If the PE 134 determines that the playlist element is associated with a piece of content, then at operation 520, the PE 134 may queue the piece of content, such as by retrieving the content, or causing it to be retrieved, according to the information in the playlist element. In various embodiments, the queued content may subsequently be presented, such as by a separate player or presentation module. In various embodiments, the queuing of the content (as well as subsequent presentation of content) may be subject to any current restrictions, such as restrictions from a higher level playlist element. In various embodiments, the queuing performed at operation 520 may be performed for the entirety of the time period, or may be performed up to the amount of space available in the queue.

In contrast, if he consulted playlist element identifies a restriction at operation 515, then, at operation 540, the PE 134 may incorporate the identified restriction for presentation of a lower-level indicated piece of content. For example, a record of the restriction may be maintained until a piece of content is identified. Next, at operation 540, the PE 134 may consult a next playlist element at a lower level of the playlist. The process may then return to decision operation 515 to continue depending on the nature of the newly-consulted playlist element.

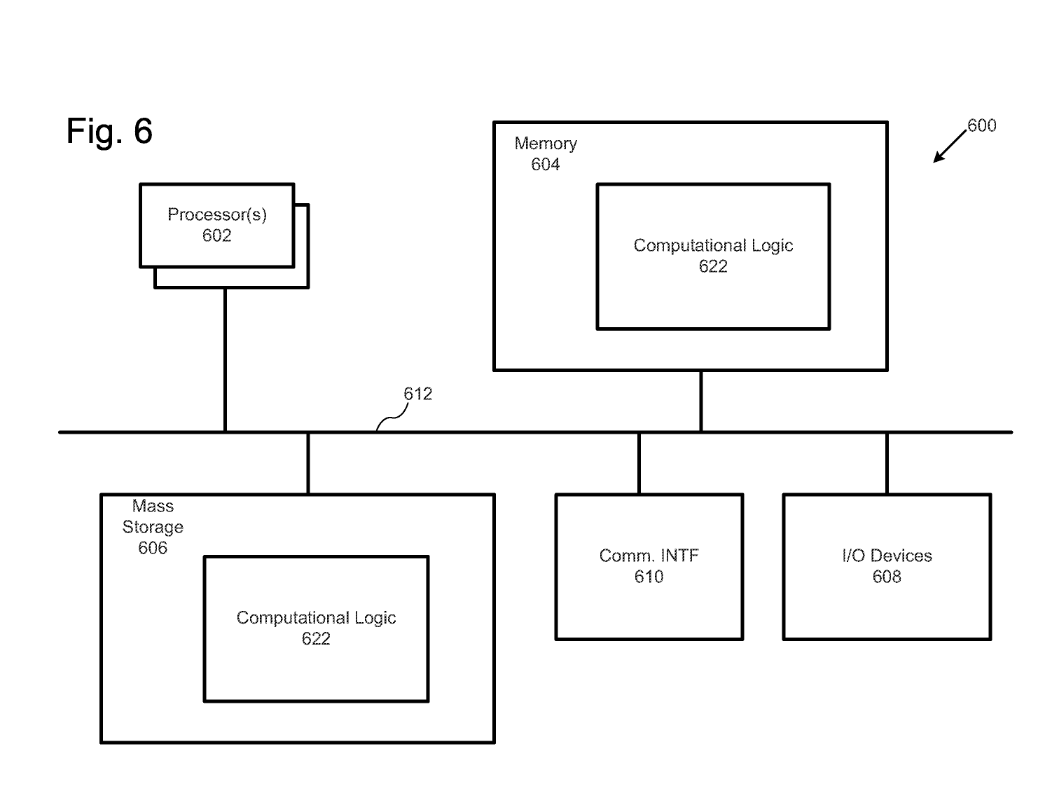

Referring now to FIG. 6, an example computer suitable for practicing various aspects of the present disclosure, including processes of FIGS. 4 and 5, is illustrated in accordance with various embodiments. As shown, computer 600 may include one or more processors or processor cores 602, and system memory 604. For the purpose of this application, including the claims, the terms “processor” and “processor cores” may be considered synonymous, unless the context clearly requires otherwise. Additionally, computer 600 may include mass storage devices 606 (such as diskette, hard drive, compact disc read only memory (CD-ROM) and so forth), input/output devices 608 (such as display, keyboard, cursor control, remote control, gaming controller, image capture device, and so forth) and communication interfaces 610 (such as network interface cards, modems, infrared receivers, radio receivers (e.g., Bluetooth), and so forth). The elements may be coupled to each other via system bus 612, which may represent one or more buses. In the case of multiple buses, they may be bridged by one or more bus bridges (not shown).

Each of these elements may perform its conventional functions known in the art. In particular, system memory 604 and mass storage devices 606 may be employed to store a working copy and a permanent copy of the programming instructions implementing the operations associated with content consumption device 108, e.g., operations associated with presentation of content based on playlists such as shown in FIGS. 4 and 5. The various elements may be implemented by assembler instructions supported by processor(s) 602 or high-level languages, such as, for example, C, that can be compiled into such instructions.

The permanent copy of the programming instructions may be placed into permanent storage devices 606 in the factory, or in the field, through, for example, a distribution medium (not shown), such as a compact disc (CD), or through communication interface 610 (from a distribution server (not shown)). That is, one or more distribution media having an implementation of the agent program may be employed to distribute the agent and program various computing devices.

The number, capability and/or capacity of these elements 610-612 may vary, depending on whether computer 600 is used as a content aggregator/distributor server 104 or a content consumption device 108 (e.g., a player 122). Their constitutions are otherwise known, and accordingly will not be further described.

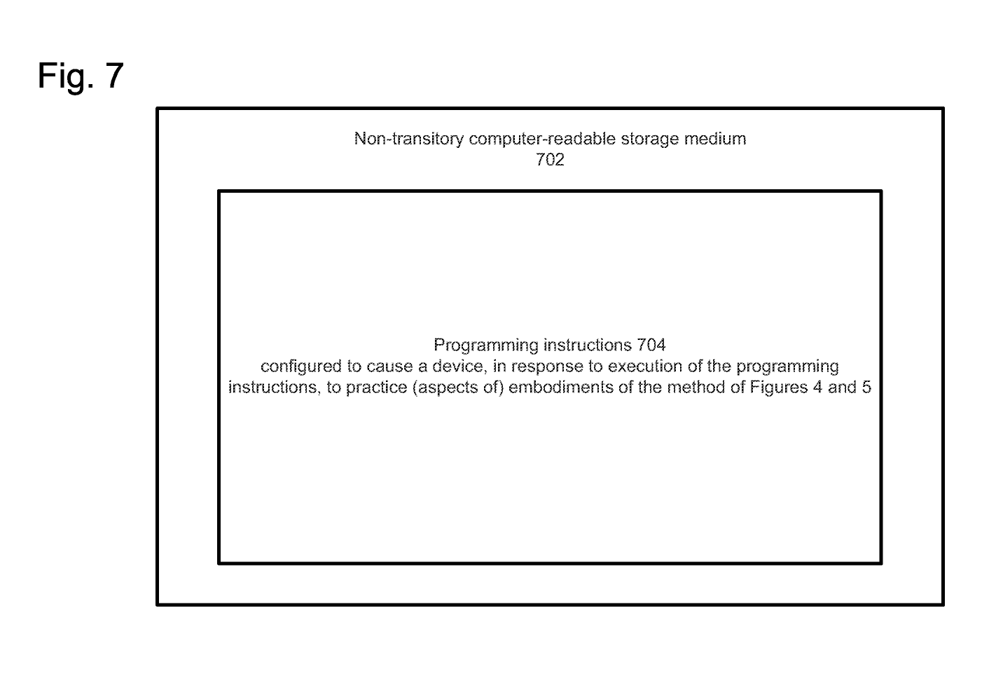

FIG. 7 illustrates an example least one computer-readable storage medium 702 having instructions configured to practice all or selected ones of the operations associated with content consumption device 108, e.g., operations associated with presentation of content based on playlists, earlier described, in accordance with various embodiments. As illustrated, least one computer-readable storage medium 702 may include a number of programming instructions 704. Programming instructions 704 may be configured to enable a device, e.g., computer 600, in response to execution of the programming instructions, to perform, e.g., various operations of processes of FIGS. 4 and 5, e.g., but not limited to, to the various operations performed to perform presentation of content based on playlists. In alternate embodiments, programming instructions 704 may be disposed on multiple least one computer-readable storage media 702 instead.

Referring back to FIG. 6, for one embodiment, at least one of processors 602 may be packaged together with computational logic 622 configured to practice aspects of processes of FIGS. 4 and 5. For one embodiment, at least one of processors 602 may be packaged together with computational logic 622 configured to practice aspects of processes of FIGS. 4 and 5 to form a System in Package (SiP). For one embodiment, at least one of processors 602 may be integrated on the same die with computational logic 622 configured to practice aspects of processes of FIGS. 4 and 5. For one embodiment, at least one of processors 602 may be packaged together with computational logic 622 configured to practice aspects of processes of FIGS. 4 and 5 to form a System on Chip (SoC). For at least one embodiment, the SoC may be utilized in, e.g., but not limited to, a computing tablet.

Various embodiments of the present disclosure have been described. These embodiments include, but are not limited to, those described in the following paragraphs.

Example 1 includes one or more computer-readable storage media including a plurality of instructions to cause one or more computing devices, in response to execution of the instructions by the computing device, to facilitate presentation of content. The computing device is caused to obtain a playlist associated with a content selection, the playlist including a plurality of playlist elements directing presentation of one or more pieces of content associated with the content selection and to facilitate presentation of the one or more pieces of content as directed by the playlist elements.

Example 2 includes the one or more computer-readable storage media of example 1, wherein at least one of the playlist elements includes an identification of a piece of content for presentation.

Example 3 includes the one or more computer-readable storage media of example 2, wherein the at least one of the playlist elements further includes an identification of a location of the piece of content.

Example 4 includes the one or more computer-readable storage media of example 2, wherein the at least one of the playlist elements further includes an offset value indicating from where within the piece of content presentation of the piece of content should begin.

Example 5 includes the one or more computer-readable storage media of example 1, wherein the at least one of the playlist elements further includes a time at which presentation of the piece of content should begin.

Example 6 includes the one or more computer-readable storage media of example 1, wherein at least one of the playlist elements includes an identification of one or more restrictions on presentation of content.

Example 7 includes the one or more computer-readable storage media of any one of examples 1-6, wherein facilitate presentation of the one or more pieces of content includes provide data for the one or more pieces of content to a player for presentation.

Example 8 includes the one or more computer-readable storage media of example 7, wherein facilitate presentation of the one or more pieces of content includes provide data for the one or more pieces of content to a queue of the player for presentation.

Example 9 includes the one or more computer-readable storage media of any one of examples 1-6, wherein obtain a playlist includes obtain a hierarchical playlist including playlist elements associated with two or more hierarchical levels.

Example 10 includes the one or more computer-readable storage media of example 9, wherein the playlist includes a plurality of playlist elements associated with a time period.

Example 11 includes the one or more computer-readable storage media of example 10 wherein facilitate presentation of the one or more pieces of content includes present the one or more pieces of content during the time period according to a playlist element having a higher level out of the plurality of playlist elements associated with a time period.

Example 12 includes the one or more computer-readable storage media of example 11, wherein:

the playlist elements associated with a time period identify a plurality of pieces of content; and

present the one or more pieces of content during the time period includes select, for presentation during the time period, a piece of content identified by the playlist element having a higher level.

Example 13 includes the one or more computer-readable storage media of example 12, wherein select a piece of content identified by the playlist element having a higher level includes select an advertisement for presentation.

Example 14 includes the one or more computer-readable storage media of example 11, wherein: at least one of the playlist elements associated with a time period identifies one or more restrictions on presentation of content and present the one or more pieces of content during the time period includes present a piece of content identified by a playlist element of a lower level than the at least one of the playlist elements that identifies one or more restrictions, the present being performed according to the one or more restrictions.

Example 15 includes the one or more computer-readable storage media of example 14, wherein present according to the one or more restrictions includes present according to one or more restrictions on playback and/or navigation of the presented piece of content.

Example 16 includes the one or more computer-readable storage media of example 14, wherein the one or more restrictions include blackout restrictions and present according to the one or more restrictions includes not presenting the piece of content when directed to not present the piece of content by the one or more blackout restrictions.

Example 17 includes an apparatus for facilitating retrieval of a file stored at multiple storage locations. The apparatus includes: one or more computing processors; a playlist setup module to operate on the one or more computing processors to obtain a playlist associated with a content selection, the playlist including a plurality of playlist elements directing presentation of one or more pieces of content associated with the content selection; and a presentation engine to facilitate presentation of the one or more pieces of content as directed by the playlist elements.

Example 18 includes the apparatus of example 17, wherein at least one of the playlist elements includes an identification of a piece of content for presentation.

Example 19 includes the apparatus of example 18, wherein the at least one of the playlist elements further includes an identification of a location of the piece of content.

Example 20 includes the apparatus of example 18, wherein the at least one of the playlist elements further includes an offset value indicating from where within the piece of content presentation of the piece of content should begin.

Example 21 includes the apparatus of example 17, wherein the at least one of the playlist elements further includes a time at which presentation of the piece of content should begin.

Example 22 includes the apparatus of example 17, wherein at least one of the playlist elements includes an identification of one or more restrictions on presentation of content.

Example 23 includes the apparatus of any one of examples 17-22, wherein facilitate presentation of the one or more pieces of content includes provide data for the one or more pieces of content to a player for presentation.

Example 24 includes the apparatus of example 23, wherein facilitate presentation of the one or more pieces of content includes provide data for the one or more pieces of content to a queue of the player for presentation.

Example 25 includes the apparatus of any one of examples 17-22, wherein obtain a playlist includes obtain a hierarchical playlist including playlist elements associated with two or more hierarchical levels.

Example 26 includes the apparatus of example 25, wherein the playlist includes a plurality of playlist elements associated with a time period.

Example 27 includes the apparatus of example 26 wherein facilitate presentation of the one or more pieces of content includes present the one or more pieces of content during the time period according to a playlist element having a higher level out of the plurality of playlist elements associated with a time period.

Example 28 includes the apparatus of example 27, wherein: the playlist elements associated with a time period identify a plurality of pieces of content and present the one or more pieces of content during the time period includes select, for presentation during the time period, a piece of content identified by the playlist element having a higher level.

Example 29 includes the apparatus of example 28, wherein select a piece of content identified by the playlist element having a higher level includes select an advertisement for presentation.

Example 30 includes the apparatus of example 27, wherein at least one of the playlist elements associated with a time period identifies one or more restrictions on presentation of content and present the one or more pieces of content during the time period includes present a piece of content identified by a playlist element of a lower level than the at least one of the playlist elements that identifies one or more restrictions, the present being performed according to the one or more restrictions.

Example 31 includes the apparatus of example 30, wherein present according to the one or more restrictions includes present according to one or more restrictions on playback and/or navigation of the presented piece of content.

Example 32 includes the apparatus of example 30, wherein the one or more restrictions include blackout restrictions and present according to the one or more restrictions includes not presenting the piece of content when directed to not present the piece of content by the one or more blackout restrictions.

Example 33 A computer-implemented method for facilitating presentation of content. The method includes obtaining, by a computing device, a playlist associated with a content selection, the playlist including a plurality of playlist elements directing presentation of one or more pieces of content associated with the content selection and facilitating presentation, by the computing device, of the one or more pieces of content as directed by the playlist elements.

Example 34 includes the method of example 33, wherein at least one of the playlist elements includes an identification of a piece of content for presentation.

Example 35 includes the method of example 34, wherein the at least one of the playlist elements further includes an identification of a location of the piece of content.

Example 36 includes the method of example 34, wherein the at least one of the playlist elements further includes an offset value indicating from where within the piece of content presentation of the piece of content should begin.

Example 37 includes the method of example 33, wherein the at least one of the playlist elements further includes a time at which presentation of the piece of content should begin.

Example 38 includes the method of example 33, wherein at least one of the playlist elements includes an identification of one or more restrictions on presentation of content.

Example 39 includes method of any one of examples 33-38, wherein facilitating presentation of the one or more pieces of content includes providing data for the one or more pieces of content to a player for presentation.

Example 40 includes the method of example 39, wherein facilitating presentation of the one or more pieces of content includes providing data for the one or more pieces of content to a queue of the player for presentation.

Example 41 includes the method of any one of examples 33-38, wherein obtaining a playlist includes obtaining a hierarchical playlist including playlist elements associated with two or more hierarchical levels.

Example 42 includes the method of example 41, wherein the playlist includes a plurality of playlist elements associated with a time period.

Example 43 includes the method of example 42 wherein facilitating presentation of the one or more pieces of content includes presenting the one or more pieces of content during the time period according to a playlist element having a higher level out of the plurality of playlist elements associated with a time period.

Example 44 includes the method of example 43, wherein the playlist elements associated with a time period identify a plurality of pieces of content and presenting the one or more pieces of content during the time period includes selecting, for presentation during the time period, a piece of content identified by the playlist element having a higher level.

Example 45 includes the method of example 44, wherein selecting a piece of content identified by the playlist element having a higher level includes selecting an advertisement for presentation.

Example 46 includes the method of example 43, wherein at least one of the playlist elements associated with a time period identifies one or more restrictions on presentation of content and presenting the one or more pieces of content during the time period includes presenting a piece of content identified by a playlist element of a lower level than the at least one of the playlist elements that identifies one or more restrictions, the presenting being performed according to the one or more restrictions.

Example 47 includes the method of example 46, wherein presenting according to the one or more restrictions includes presenting according to one or more restrictions on playback and/or navigation of the presented piece of content.

Example 48 includes the method of example 46, wherein the one or more restrictions include blackout restrictions and presenting according to the one or more restrictions includes not presenting the piece of content when directed to not present the piece of content by the one or more blackout restrictions.

Example 49 includes an apparatus for facilitating presentation of content. The apparatus includes means for obtaining a playlist associated with a content selection, the playlist including a plurality of playlist elements directing presentation of one or more pieces of content associated with the content selection and means for facilitating presentation of the one or more pieces of content as directed by the playlist elements.

Example 50 includes the apparatus of example 49, wherein at least one of the playlist elements includes an identification of a piece of content for presentation.

Example 51 includes the apparatus of example 50, wherein the at least one of the playlist elements further includes an identification of a location of the piece of content.

Example 52 includes the apparatus of example 50, wherein the at least one of the playlist elements further includes an offset value indicating from where within the piece of content presentation of the piece of content should begin.

Example 53 includes the apparatus of example 49, wherein the at least one of the playlist elements further includes a time at which presentation of the piece of content should begin.

Example 54 includes the apparatus of example 49, wherein at least one of the playlist elements includes an identification of one or more restrictions on presentation of content.

Example 55 includes the apparatus of any one of examples 49-54, wherein means for facilitating presentation of the one or more pieces of content includes means for providing data for the one or more pieces of content to a player for presentation.

Example 56 includes the apparatus of example 55, wherein means for facilitating presentation of the one or more pieces of content includes means for providing data for the one or more pieces of content to a queue of the player for presentation.

Example 57 includes the apparatus of any one of examples 49-54, wherein means for obtaining a playlist includes means for obtaining a hierarchical playlist including playlist elements associated with two or more hierarchical levels.

Example 58 includes the apparatus of example 57, wherein the playlist includes a plurality of playlist elements associated with a time period.

Example 59 includes the apparatus of example 58, wherein means for facilitating presentation of the one or more pieces of content includes means for presenting the one or more pieces of content during the time period according to a playlist element having a higher level out of the plurality of playlist elements associated with a time period.

Example 60 includes the apparatus of example 59, wherein the playlist elements associated with a time period identify a plurality of pieces of content and means for presenting the one or more pieces of content during the time period includes means for selecting, for presentation during the time period, a piece of content identified by the playlist element having a higher level.

Example 61 includes the apparatus of example 60, wherein means for selecting a piece of content identified by the playlist element having a higher level includes means for selecting an advertisement for presentation.

Example 62 includes the apparatus of example 59, wherein at least one of the playlist elements associated with a time period identifies one or more restrictions on presentation of content and means for presenting the one or more pieces of content during the time period includes means for presenting a piece of content identified by a playlist element of a lower level than the at least one of the playlist elements that identifies one or more restrictions, the presenting being performed according to the one or more restrictions.

Example 63 includes the apparatus of example 62, wherein means for presenting according to the one or more restrictions includes means for presenting according to one or more restrictions on playback and/or navigation of the presented piece of content.

Example 64 includes the apparatus of example 62, wherein the one or more restrictions include blackout restrictions and means for presenting according to the one or more restrictions includes means for not presenting the piece of content when directed to not present the piece of content by the one or more blackout restrictions.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable storage media comprising a plurality of instructions to cause one or more computing devices, in response to execution of the instructions by the computing device, to:
obtain a playlist associated with a content selection, the playlist comprising a plurality of playlist elements directing presentation of one or more pieces of content associated with the content selection; and
facilitate presentation of the one or more pieces of content as directed by the playlist elements.

2. The one or more computer-readable storage media of claim 1, wherein at least one of the playlist elements comprises an identification of a piece of content for presentation.

3. The one or more computer-readable storage media of claim 2, wherein the at least one of the playlist elements further comprises one or more of an identification of a location of the piece of content, an offset value indicating from where within the piece of content presentation of the piece of content should begin, and a time at which presentation of the piece of content should begin.

4. The one or more computer-readable storage media of claim 1, wherein at least one of the playlist elements comprises an identification of one or more restrictions on presentation of content.

5. The one or more computer-readable storage media of claim 1, wherein facilitate presentation of the one or more pieces of content comprises provide data for the one or more pieces of content to a player for presentation.

6. The one or more computer-readable storage media of claim 5, wherein facilitate presentation of the one or more pieces of content comprises provide data for the one or more pieces of content to a queue of the player for presentation.

7. The one or more computer-readable storage media of claim 1, wherein obtain a playlist comprises obtain a hierarchical playlist comprising playlist elements associated with two or more hierarchical levels.

8. The one or more computer-readable storage media of claim 7, wherein the playlist comprises a plurality of playlist elements associated with a time period.

9. The one or more computer-readable storage media of claim 8 wherein facilitate presentation of the one or more pieces of content comprises present the one or more pieces of content during the time period according to a playlist element having a higher level out of the plurality of playlist elements associated with a time period.

10. The one or more computer-readable storage media of claim 9, wherein:
the playlist elements associated with a time period identify a plurality of pieces of content; and
present the one or more pieces of content during the time period comprises select, for presentation during the time period, a piece of content identified by the playlist element having a higher level.

11. The one or more computer-readable storage media of claim 10, wherein select a piece of content identified by the playlist element having a higher level comprises select an advertisement for presentation.

12. The one or more computer-readable storage media of claim 9, wherein:
at least one of the playlist elements associated with a time period identifies one or more restrictions on presentation of content; and
present the one or more pieces of content during the time period comprises present a piece of content identified by a playlist element of a lower level than the at least one of the playlist elements that identifies one or more restrictions, the present being performed according to the one or more restrictions.

13. The one or more computer-readable storage media of claim 12, wherein present according to the one or more restrictions comprises present according to one or more restrictions on playback and/or navigation of the presented piece of content.

14. The one or more computer-readable storage media of claim 12, wherein:
the one or more restrictions comprise blackout restrictions; and
present according to the one or more restrictions comprises not presenting the piece of content when directed to not present the piece of content by the one or more blackout restrictions.

15. An apparatus, comprising:
one or more computing processors;
a playlist setup module to operate on the one or more computing processors to obtain a playlist associated with a content selection, the playlist comprising a plurality of playlist elements directing presentation of one or more pieces of content associated with the content selection; and
a presentation engine to facilitate presentation of the one or more pieces of content as directed by the playlist elements.

16. The apparatus of claim 15, wherein at least one of the playlist elements comprises an identification of a piece of content for presentation and one or more of: a location of the piece of content, and an offset value indicating from where within the piece of content presentation of the piece of content should begin, a time at which presentation of the piece of content should begin, and an identification of one or more restrictions on presentation of content.

17. The apparatus of claim 15, wherein facilitate presentation of the one or more pieces of content comprises provide data for the one or more pieces of content to a queue of a player for presentation.

18. The apparatus of claim 15, wherein:
obtain a playlist comprises obtain a hierarchical playlist comprising playlist elements associated with two or more hierarchical levels;
the playlist comprises a plurality of playlist elements associated with a time period; and
facilitate presentation of the one or more pieces of content comprises present the one or more pieces of content during the time period according to a playlist element having a higher level out of the plurality of playlist elements associated with a time period.

19. The apparatus of claim 18, wherein:
at least one of the playlist elements associated with a time period identifies one or more restrictions on presentation of content; and
present the one or more pieces of content during the time period comprises present a piece of content identified by a playlist element of a lower level than the at least one of the playlist elements that identifies one or more restrictions, the present being performed according to the one or more restrictions.

20. The apparatus of claim 19, wherein present according to the one or more restrictions comprises present according to one or more restrictions on playback and/or navigation of the presented piece of content.

21. A computer-implemented method, comprising:
obtaining, by a computing device, a playlist associated with a content selection, the playlist comprising a plurality of playlist elements directing presentation of one or more pieces of content associated with the content selection; and
facilitating presentation, by the computing device, of the one or more pieces of content as directed by the playlist elements.

22. The method of claim 21, wherein at least one of the playlist elements comprises an identification of a piece of content for presentation and one or more of: a location of the piece of content, an offset value indicating from where within the piece of content presentation of the piece of content should begin, a time at which presentation of the piece of content should begin, and an identification of one or more restrictions on presentation of content.

23. The method of claim 21, wherein obtaining a playlist comprises obtaining a hierarchical playlist comprising playlist elements associated with two or more hierarchical levels.

24. The method of claim 23, wherein:
the playlist comprises a plurality of playlist elements associated with a time period; and
facilitating presentation of the one or more pieces of content comprises presenting the one or more pieces of content during the time period according to a playlist element having a higher level out of the plurality of playlist elements associated with a time period.
